(19) United States
(12) Patent Application Publication
(10) Pub. No.: US 2005/0164797 A1
(43) Pub. Date: Jul. 28, 2005

(54) Apparatus and method for recording and assessing bowling data

(76) Inventor: Evan M. Jacover, Chicago, IL (US)

Correspondence Address: Jerold A. Jacover;Brinks Hofer Gilson & Lione, NBC Tower, Suite 3600, P.O. Box 10395, Chicago, IL, 60610, US

(21) Appl. No.: 10/766,592

(22) Filed: Jan. 26, 2004

(51) Int. Cl. G06F 17/00

(52) U.S. Cl. 473/70

(57) ABSTRACT

An apparatus and method for sending bowling scoring information associated with identification information to an internet-accessible data base is disclosed. The apparatus and method permit at least a version of some of the scoring information associated with the identification information to be passed to the data base via the internet without manually inputting the information into a computer.

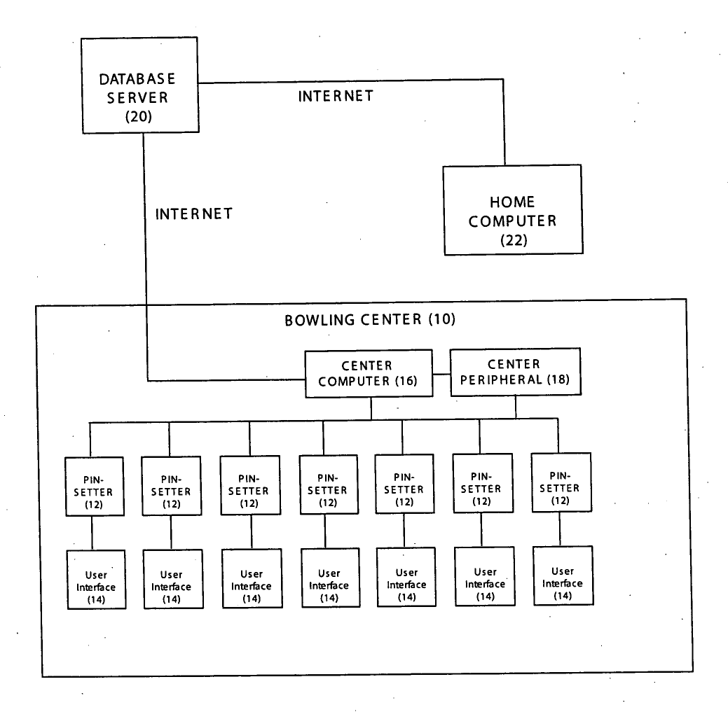

### BACKGROUND

This invention generally pertains to an apparatus and method for recording and accessing bowling data. Such data is most often related to individual bowling scores, averages, “high” games and the like. In addition, such data may include information pertaining to teams and leagues to which individual bowlers belong, team averages, and numerous other calculations and statistics that may be of interest to bowlers. More particularly, this invention pertains to an apparatus and method for automatically recording and storing bowling scoring information in a manner that permits such information, and related statistics, to be accessed via the internet.

Bowling is a recreational sport in which an individual bowler rolls a ball down a lane in an attempt to knock down ten pins placed in an isosceles triangular arrangement, with the apex of the triangle facing the bowler. A bowler ordinarily gets two such attempts to knock down all ten pins, those two attempts being collectively referred to in bowling parlance as a “frame.” Ten frames equals one game. Scoring is based on the number of pins knocked down, and is typically kept on a frame-by-frame basis. Bonuses are earned for a “strike,” which occurs when the bowler knocks down all ten pins on the first attempt in a frame, or for a “spare,” which occurs when the bowler knocks down all ten pins after both attempts in a frame.

Modern bowling centers typically include numerous bowling lanes, each lane having associated therewith a mechanical device known as an automatic pin setter. Among other things, each of these automatic pin setters sweep knocked-down bowling pins from the bowling lane after the bowler's first attempt in a frame, while leaving the pins that were not knocked down in position for the bowler's second attempt in the frame. Simultaneously, the bowling ball is returned to the bowler for the second attempt. After a frame is concluded, the automatic pin setter resets the pins in their conventional triangular arrangement, and again returns the ball to the bowler, in readiness for the next frame.

Modern pin setters of the type described typically have many other features. These include the capability of identifying the number of pins knocked down after each attempt by a bowler. In addition, such pin setters can generate data that can be used for automatically calculating the bowler's frame-by-frame score, as well as the bowler's final game score. Such pin setters are conventional, and well known in the art.

With the advent of cheaper and faster electronics, bowling centers have integrated additional technology into their bowling establishments. This technology often includes a user interface associated with each automatic pin setter. Such a user interface is typically located in close proximity to the end of the lane, opposite the placement of the pins, from which a bowler releases the ball. Among other things, a user interface of the type described includes a data receiving mechanism, whereby one or more bowlers may input certain bowler identification information. This bowler identification information may include the bowler's name, team, league, or some code, typically in numeric form, indicative thereof. In this way, the automatic pin setters have the capability of, not only calculating a bowler's score, but associating the bowler's score and other scoring information, with a bowler's name, team, league or other identification.

Technology in modem bowling centers may also include a bowling center peripheral. Such a bowling center peripheral may be in communication with one or more of the above-described pin setters, sometimes referred to individually or collectively herein as a pin setter data generator. The bowling center peripheral may format the bowling scoring information developed by the pin setter data generator to provide bowling score information that is readable by an individual bowler via a monitor, or reproduced in printed form. Additionally, the bowling center peripheral may provide numerous other types of individual, team or league scoring information, such as a frame-by-frame score of the games bowled by an individual bowler.

Sometimes a bowling establishment, bowling league, or even a bowling team, or team member, may establish a bowling-related web site for use by various individuals such as patrons, league members or bowling team members. In such situations one or more persons may assume the role of a statistician. Among other things, it is the task of the statistician to collect bowling scoring information from available sources, such as handwritten score sheets or the bowling center peripheral, and manually enter that information into a computer, server, or the like, that may be in communication with an associated bowling-related web site. The computer, server, or the like, associated with the bowling-related web site may be managed in such a way as to calculate statistics such as averages, “high” games, etc., for individual bowlers, or scores, standings, etc. for various teams and leagues. Interested and authorized individuals may then access the bowling-related web site to obtain these statistics.

Unfortunately, it takes substantial time and effort on the part of the statistician to collect and manually enter all of the data needed to provide such statistics. Moreover, the task of manually inputting such a large amount of data is a tedious one, and is also prone to error. In addition, it is highly desirable that the information be input promptly after the individual bowling games have been concluded, not only because individuals are often eager to see the new statistics shortly after each game or competition is completed, but because the raw information can be easily lost or misplaced. For these and other reasons, the above-described apparatus and methods for recording bowling statistics and/or entering bowling information onto a web site, suffers from numerous drawbacks and deficiencies.

It is a primary object of the invention to overcome these aforementioned drawbacks and deficiencies. It is another object of the invention to provide an improved apparatus and method for recording bowling information. Other objects, features and advantages of the invention will be apparent from reading the detailed description of the invention briefly summarized below.

### BRIEF SUMMARY

In one aspect, the objects of the present invention are achieved in a bowling establishment apparatus for sending bowling scoring information and associated identification information to an internet-accessible data base. The apparatus includes a user interface, having an input and an output, adapted to receive identification information associated with an individual bowler. The apparatus also includes a pin setter data generator, having an input communicating with the output of the user interface, which automatically ascertains bowler scoring information associated with an individual bowler. The apparatus further includes an internet-accessible computer, which may be separate from, or incorporated in, the pinsetter data generator, and/or the user interface. The computer is adapted to automatically receive bowler scoring information associated with an individual bowler, and send at least a version of some of the bowling scoring information via the internet to the internet accessible data base, whereby at least a version of some of the bowling scoring information can be accessed via the internet without having been manually input into the computer.

In another aspect, the objects of the invention are achieved in a method for sending bowling scoring information and associated identification information to an internet-accessible data base. The method comprises providing a user interface having an input and an output, the input adapted to receive identification information associated with an individual bowler. The method further comprises providing a pin setter data generator, having an input communicating with the output of the user interface, which automatically ascertains bowler scoring information associated with an individual bowler. The method also comprises providing an internet-accessible computer, which may be separate from, or incorporated in, the pinsetter data generator and/or the user interface. The computer automatically receives the bowling scoring information associated with an individual bowler, and sends at least a version of the bowling scoring information to the internet-accessible data base, whereby at least a version of some of the bowling scoring information can be accessed via the internet without having been manually input into the computer.

### BRIEF DESCRIPTION OF THE DRAWING

The invention summarized above can be better understood by reference to the accompanying drawing which is a block diagram of an embodiment of the invention. The block diagram has various sub-blocks, some of which are diagrammatically attached by bold lines. Both the sub-blocks and the bold lines are for illustrative purposes only and should not be construed as limitative, the scope of the invention being defined by the appended claims.

### DETAILED DESCRIPTION OF THE DRAWING AND THE PRESENTLY PREFERRED EMBODIMENTS

Referring now to the drawing, a bowling center is represented generally by reference numeral 10. The bowling center typically has a plurality of bowling lanes (not shown) well-known to any bowling patron. Conventionally associated with each bowling lane is an automatic pin setter 12, sometimes referred to herein as a pin setter data generator. As explained above, pin setters 12 serve to automatically set and reset pins knocked down by a bowler, identify the pins knocked down and/or remaining after each roll of the ball by a bowler, and return the ball to the bowler after each roll. Pin setters of the type described are well-known in the art, an exemplary pin spotter being marketed as AMF 90 KL by AMF Bowling Worldwide, Inc. which is hereby incorporated by reference.

Preferably associated with each pin setter 12 is a user interface 14. User interface 14 enables a bowler to input bowler identification information, such as an individual name, via a keypad, touch screen, or the like. Additional information, such as team names, league names, dates, locations and the like could also be input via user interface 14. User interface 14 conventionally works in conjunction with pin setter 12 to automatically ascertain the bowler's score on a frame-by-frame and/or game-by game basis. Other statistical information such as series totals and game averages may also be ascertained. An exemplary user interface 14 is also available from AMF Bowling Worldwide, Inc., marketed under the name BOSS Scoring, incorporated herein by reference. Typically associated with the AMF BOSS Scoring user interface is an AMD AccuCam 3000 scoring camera which not only enables accurate scoring, but provides additional graphics, animations and instructions throughout the game.

Other pin setters and user interface apparatus are also available from other companies. One such company is Brunswick Corp. Its pinsetters are marketed under the name GS-X, and its user interfaces are marketed under the name Center Network Systems Framework™ and Center Network Systems Classic™, also incorporated herein by reference.

Associated with, incorporated in, or coupled to pinsetters 12 and/or user interfaces 14 is a bowling center peripheral 18. As explained above, bowling center peripheral 18 formats the bowling scoring information developed by the pin setter data generator to provide bowling scoring information that is readable by an individual bowler via a monitor, or reproduced in printed form. If needed, the bowling center peripheral 18 may also provide a formatted version of the bowler identification and bowler scoring information to a bowling center computer 16 in a manner readily understandable to a person skilled in the art. It should be understood, however, that bowling center computer 16 need not be a separate apparatus, but may be incorporated in pin setters 12 and/or user interfaces 14. As such, it should be understood that the blocks shown in the drawing, such as those represented by reference numerals 12, 14, 16, and 18 need not be discrete pieces of equipment. Similarly, the bold lines connected thereto need not be separate interconnections, the aforementioned blocks and bold lines being illustrated for illustrative purposes only, and should not be construed as limitations.

As shown in the drawing, bowling center computer 16 is coupled to the pin setters 12, the user interfaces 14, and the bowling center peripheral 18, all of which are preferably located in the bowling center. In one embodiment of the invention, the bowler identification information and the bowler scoring information obtained via pin setters 12, interfaces 14, and/or peripheral 18, or at least a version thereof, is automatically provided to computer 16. Bowling center computer 16 may, of course, incorporate peripheral 18.

Bowling center computer 16 is operable to communicate the bowler identification information and the bowler scoring information via the internet in a manner understood by a person skilled in the art. This may be done automatically in real time, automatically after a pre-determined time delay, on command, upon actuation of a switch, etc. Computer 16 may run on any computer operating system, such as a Linux, in a manner familiar to those skilled in the art, such that the above-described internet communication can be achieved.

In one embodiment of the invention there is also provided a data base server 20. The data base server 20 may include a database and a web server, which are familiar to those skilled in the art. An exemplary data base may be MySQL, and an exemplary http web server may be Apache. In an manner well known in the art, the bowling identification information and the bowling scoring information is passed via the internet from computer 16 to data base server 20.

In one aspect of the invention, a webmaster may communicate with the date base server 20 by any conventional means, such as a home computer 22. The web master may serve, for example, as a bowling league statistician. In this capacity the web master could arrange all of the bowling identification information and bowling scoring information in any chosen way. By way of example, the web master could list the scores for individual games and series for each bowler. Averages, high games/series, etc. could also be listed. These lists could also be compiled on an individual, team or league basis. Importantly, because all the raw information is automatically sent to computer 16 via pin setters 12, user interfaces 14, and/or peripheral 18, the web master does not have to re-enter all of this data. Moreover, once the data base server is properly programmed, much of the individual, team and league information can be calculated and arranged automatically. This, of course, results in an enormous savings in time and a substantial increase in accuracy.

The data base server 20 could also be accessed by individual bowlers, based on parameters, codes and passwords arranged by the web master. Such access could be obtained through the bowlers' own personal computers (not shown) that have internet capability. Thus, any bowler, under appropriate security conditions, can conveniently access data base server 20, and thereby instantaneously ascertain the relevant bowling individual, team and league statistics.

In view of the foregoing, an exemplary operation of the apparatus and methods of the invention would occur as follows: Individual bowlers at a bowling center would enter personal, team, and/or league identification information via interface 14. The bowling scoring information, corresponding to each individual bowler would then be obtained in real-time on a frame-by-frame, game-by-game basis by pinsetters 12. Appropriate peripherals 18 would, if necessary, convert the bowling scoring information and associated identification information into a format that can be automatically received and used by computer 16. Computer 16 would then automatically transfer the scoring and associated identification information in real time, after a predetermined delay, or upon command, to the data base server 20 via the internet. With the data base server 20 properly programmed by a web master or statistician, the bowling scoring and identification information can be readily accessed by an authorized person, via any internet-accessible device such as a personal computer.

Though the various aspects and operations described above are preferred, those skilled in the art may conceive other variations which do not part from the true scope of the invention. Accordingly, all such variations are intended to be covered by the appended claims. It should also be understood that the foregoing detailed description should be regarded as illustrative rather than limiting. As such, it is the claims, including all equivalents, that are intended to define the spirit and scope of this invention.

1. A bowling establishment apparatus for sending bowling scoring information associated with identification information to an internet-accessible data base comprising:
a user interface, having an input and an output, said input adapted to receive identification information associated with an individual bowler;
a pin setter data generator, having an input communicating with the output of said user interface, which automatically ascertains bowler scoring information associated with an individual bowler;
an internet-accessible computer, adapted to automatically receive at least a version pf some of said bowler scoring information associated with an individual bowler, and send at least a version of some of said bowling scoring information via the internet to said internet accessible data base, whereby at least a version of some of said bowling scoring information is sent to said data base without having been manually input into said computer.

2. The apparatus defined in claim 1, wherein said computer receives said bowling scoring information for a multiplicity of games associated with an individual bowler from which bowling game scoring information can be ascertained.

3. The apparatus defined in claim 1, wherein said computer receives said bowling scoring information for a multiplicity of individual bowlers comprising a bowling team from which bowling team scoring information can be ascertained.

4. The apparatus defined in claim 1, wherein said computer receives said bowling scoring information for a multiplicity of bowling teams comprising a bowling league from which bowling league scoring information can be ascertained.

5. The apparatus defined in claim 1 wherein said bowling scoring information received by said computer can be used to ascertain bowling game scoring information, bowling team information and bowling league information, and at least a version of some of said bowling game scoring information, bowling team information or bowling league information can be passed to said internet-accessible data base and converted into bowling statistics, whereby bowling statistics pertaining to individual, team and league performance can be accessed via the internet.

6. The apparatus recited in claim 1 wherein said pin setter data generator comprises a plurality of automatic pin setters each associated with different bowling lanes in said bowling establishment, each of said pin setters automatically ascertaining bowling scoring information for the bowlers who are bowling on respective ones of said different bowling lanes.

7. The apparatus recited in claim 6, wherein said bowling scoring information for said bowlers who are bowling on respective ones of said different bowling lanes is simultaneously passed to said computer.

8. The apparatus recited in claim 1 wherein said computer is programmed to automatically format said bowling scoring information received from said pin setter data generator, and automatically pass said formatted bowling scoring information to said data base.

9. The apparatus defined in claim 8 wherein said formatted bowling scoring information can be utilized to generate individual, team and league bowling statistics.

10. The apparatus recited in claim 9 further includes a server comprising a computer-managed web site in communication with said internet-accessible data base for receiving said bowling scoring information therefrom, and wherein said computer-managed web site is arranged so that said individual, team and league bowling statistics can be put on said web site and obtained via the internet.

11. The apparatus defined in claim 1 wherein at least version of some of said bowling information associated with an individual bowler is also automatically sent to said data base.

12. The apparatus defined in claim 1 wherein, at least a version of some of said bowling information associated with an individual bowler is sent on command to said data base.

13. A method for sending bowling scoring information associated with identification information to an internet-accessible data base comprising:
providing a user interface, having an input and an output, said input adapted to receive identification information associated with an individual bowler;
providing a pin setter data generator, having an input communicating with the output of said user interface, which automatically ascertains bowling scoring information associated with an individual bowler;
automatically passing at least a version of some of said bowling scoring information associated with said identification information to a computer; and
passing at least a version of some of said bowling scoring information associated with said identification information without having to manually input said version into said computer.
